(19) United States
(12) Patent Application Publication
(10) Pub. No.: US 2010/0092675 A1
(43) Pub. Date: Apr. 15, 2010

(54) INK JET RECORDING METHOD, INK CARTRIDGE, AND RECORDING DEVICE

(75) Inventor: Katsuko Aoki, Kiso-machi (JP)

Correspondence Address: LADAS & PARRY, 26 West 61st Street, New York, NY, 10023, US

(73) Assignee: SEIKO EPSON CORPORATION

(21) Appl. No.: 12/578,622

(22) Filed: Oct. 14, 2009

(30) Foreign Application Priority Data
Oct. 14, 2008 (JP) 2008-264741

(51) Int. Cl. B05D 5/00; C09D 11/02

(52) U.S. Cl. 427/256; 106/31.13

(57) ABSTRACT

An ink jet recording method for forming an image by adhering water-based ink to a non-absorbing or low-absorbing medium, including: forming an image while heating the medium, in which the water-based ink contains a first solvent having a boiling point of 210° C. to 280° C., a second solvent having a boiling point of 150° C. to 280° C., a water-insoluble colorant, a water-soluble resin, thermoplastic resin particles, a silicon surfactant, and water, and the surface tension when the first solvent is formed into an aqueous solution is lower than the surface tension when the second solvent is formed into an aqueous solution.

### BACKGROUND

1. Technical Field

The present invention relates to an ink jet recording method, an ink cartridge, and a recording device.

2. Related Art

The ink jet recording method is a printing method including discharging and flying small ink droplets from a minute nozzle head, and adhering the same to a recording medium, such as paper, for printing. This method allows high speed printing of a high resolution and high quality image by a relatively inexpensive apparatus.

In recent years, a technique of carrying out recording on a non-water absorbing medium, such as plastics, using the ink jet recording method has been proposed. For example, an ink composition for ink jet suitably used in direct printing on a hydrophobic base (JP-A-2000-44858) or a polymer colloid containing ink jet ink (JP-A-2005-220352) that can be printed on a nonporous base has been proposed.

However, when recorded on a non-absorbing or low-absorbing medium, there arises a problem in that ink blurs, and thus the image quality deteriorates, irrespective of whether or not heating is carried out during recording.

### SUMMARY

An advantage of some aspects of the invention is to provide an ink jet recording method, an ink cartridge, and a recording device that allow high image quality recording using water-based ink on a non-absorbing or low-absorbing medium having no ink receiving layer.

The invention provides:

(1) An ink jet recording method for forming an image by adhering water-based ink to a non-absorbing or low-absorbing medium, including: forming an image while heating the medium, in which the water-based ink contains a first solvent having a boiling point of 210° C. to 280° C., a second solvent having a boiling point of 150° C. to 280° C., a water-insoluble colorant, a water-soluble resin, thermoplastic resin particles, a silicon surfactant, and water, and the surface tension when the first solvent is formed into an aqueous solution is lower than the surface tension when the second solvent is formed into an aqueous solution;

(2) The ink jet recording method according to the first aspect, in which the boiling point of the second solvent is 150° C. to lower than 210° C. and the amount of ink droplets to be adhered to the medium is 3 ng to 30 ng;

(3) The ink jet recording method according to the first aspect, in which the boiling point of the second solvent is 210° C. to 280° C. and the amount of ink droplets to be adhered to the medium is 3 ng to 15 ng;

(4) The ink jet recording method according to the first to third aspects, in which the content of the silicon surfactant in the water-based ink is 0.1 mass % to 1.5 mass %;

(5) The ink jet recording method according to the first to fourth aspects, in which the heating temperature of the medium is 40° C. to 80° C.;

(6) An ink cartridge, containing water-based ink containing a first solvent having a boiling point of 210° C. to 280° C., a second solvent having a boiling point of 150° C. to 280° C., a water-insoluble colorant, a water-soluble resin, thermoplastic resin particles, a silicon surfactant, and water, in which the surface tension when the first solvent is formed into an aqueous solution is lower than the surface tension when the second solvent is formed into an aqueous solution;

(7) A recording device, which is used for the ink jet recording method according to any one of the first to fifth aspects; and

(8) A recording device, having the ink cartridge according to the sixth aspect.

According to the ink jet recording method of the invention, when recorded on a non-absorbing or low-absorbing medium, nonuniform agglomeration of the water-based ink does not occur, and thus a high quality image can be obtained.

### DESCRIPTION OF EXEMPLARY EMBODIMENTS

Next, embodiments of the invention will be described. The following embodiments are only exemplifications for describing the invention and are not intended to limit the invention to the embodiments. The invention can be implemented in various modes insofar as they do not depart from the scope.

An ink jet recording method of the invention is an ink jet recording method for forming an image by adhering water-based ink to a non-absorbing or low-absorbing medium. The method includes forming an image while heating the medium, in which the water-based ink contains a first solvent having a boiling point of 210° C. to 280° C., a second solvent having a boiling point of 150° C. to 280° C., a water-insoluble colorant, a water-soluble resin, thermoplastic resin particles, a silicon surfactant, and water, and the surface tension when the first solvent is formed into an aqueous solution is lower than the surface tension when the second solvent is formed into an aqueous solution.

According to the ink jet recording method of the invention, when recorded on a non-absorbing or low-absorbing medium, nonuniform agglomeration of the water-based ink does not occur, and thus a high quality image can be obtained.

By the use of the water-based ink containing the first solvent and the second solvent, adhesion of the resins in the water-based ink can be prevented. Here, “in the ink” refers to a range from an ink cartridge containing the water-based ink to the nozzle tip of a head from which the water-based ink is discharged. Since the adhesion of the resins in the water-based ink can be prevented, the water-based ink becomes difficult to solidify, and thus poor ink discharging, such as clogging, can be prevented.

Here, the non-absorbing or low-absorbing recording medium (medium) refers to a recording medium whose printing surface has a water absorption amount from the initiation of contact to 30 msec^{1/2} in the Bristow method of 10 mL/m² or lower. The Bristow method is the most popular method as a method for measuring the liquid absorption amount in a short time, and is also employed in JAPAN TAPPI. The details of a test method are described in “Liquid Absorbency Test Method of Paper and Paperboard (Bristow Method)” of No. 51 of “JAPAN TAPPI paper pulp test method, 2000”.

As an example of such a recording medium, one in which plastics are coated on a base, such as a plastic film or paper that has not been surface treated for ink jet printing (i.e., an ink absorption layer is not formed), one in which a plastic film has been adhered thereto, etc., are mentioned, for example, as the non-ink absorbing recording medium. As the plastics mentioned here, polyvinyl chloride, polyethylene terephthalate, polycarbonate, polystyrene, polyurethane, polyethylene, polypropylene, etc., are mentioned. As the low-ink absorbing recording medium, printing paper, such as art paper, coated paper, or mat paper, is mentioned.

### First and Second Solvents

As the first solvent, 1,2-hexanediol, triethylene glycol monobutyl ether, 1,3-propanediol, etc., are mentioned.

As the second solvent, propylene glycol, diethylene glycol, N-methyl-2-pyrrolidone, 1,5-pentanediol, etc., are mentioned.

In the ink jet recording method, when the boiling point of the second solvent is lower than 150° C. to 210° C., it is preferable that the amount of ink droplets to be adhered to the medium be 3 ng to 30 ng.

In the ink jet recording method, when the boiling point of the second solvent is 210° C. to 280° C., it is preferable that the amount of ink droplets to be adhered to the medium be 3 ng to 15 ng.

Based on the fact that, when formed into aqueous solutions of the first and the second solvents, the static surface tension of the first solvent is lower than that of the second solvent, the wettability to the medium can be increased. In particular, when printing is carried out under heating as in the invention, drying of the solvent progresses during printing. Therefore, by adjusting the remaining period of time of the first solvent having a relatively high boiling point in the medium to be longer than that of the second solvent having a relatively low boiling point, a favorable image is obtained.

Thus, by adjusting the dot size or the solvent type of the ink to an optimum range, adhesion between the ink dots and nonuniform agglomeration of the ink when recorded on the non-absorbing or low-absorbing medium are prevented, thereby obtaining a higher image quality.

The water-based ink further contains a water-insoluble colorant, a water-soluble resin, thermoplastic resin particles, and a silicon surfactant.

### Water-Insoluble Colorant

As a water-insoluble colorant, water-insoluble dyes or pigments are mentioned, and pigments are preferable. Pigments have properties of being insoluble or difficult to dissolve in water and moreover being difficult to fade by light, gas, etc. Therefore, recorded matter obtained by printing with an ink composition using such a pigment are excellent in water resistance, gas resistance, lightfastness, etc., and is imparted with favorable storage ability.

As the pigments, any of known inorganic pigments, organic pigments, and carbon blacks can be used. Among the above, carbon blacks and organic pigments are preferable from the viewpoint that they exhibit favorable coloring and they are hard to precipitate during dispersion due to a low specific gravity.

Specific examples of preferable carbon blacks include furnace black, lamp black, acetylene black, and channel black (C.I. pigment black 7). Examples of commercially available carbon blacks include No. 2300, 900, MCF88, No. 20B, No. 33, No. 40, No. 45, No. 52, MA7, MA8, MA100, and No. 2200B (trade names, all manufactured by Mitsubishi Chemical, Inc.), Color black FW1, FW2, FW2V, FW18, FW200, 5150, S160, 5170, Pritex 35, U, V, 140U, Special black 6, 5, 4A, 4, and 250 (trade names, all manufactured by Degussa AG), Conductex SC, Raven 1255, 5750, 5250, 5000, 3500, 1255, and 700 (trade names, all manufactured by Colombia Carbon), Regal 400R, 330R, and 660R, Mogul L, Monarch 700, 800, 880, 900, 1000, 1100, 1300, and 1400, and Elftex 12 (trade names, all manufactured by Cabot Corp.). The carbon blacks above are simply mentioned as one example of carbon blacks suitable for the invention, and the invention is not limited by the description. These carbon blacks may be used singly or as a mixture of two or more thereof. The content of these carbon blacks is 0.5 mass % to 20 mass % and preferably 1 mass % to 10 mass % based on the total amount of a black ink composition.

Examples of preferable organic pigments include quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perynone pigments, quinophthalone pigments, anthraquinone pigments, thioindigo pigments, benzimidazolone pigments, isoindolinone pigments, azomethine pigments, and azo pigments.

The following organic pigments are mentioned as a specific example of organic pigments to be used in the water-based ink for use in the recording method according to this Embodiment.

Examples of pigments for use in a cyan ink composition include C.I. pigment blue 1, 2, 3, 15:3, 15:4, 15:34, 16, 22, and 60; and C.I. Vat blue 4 and 60, and preferably, examples include a single pigment or a mixture of two or more pigments selected from the group consisting of C.I. pigment blue 15:3, 15:4, and 60. The content of the pigments is about 0.5 mass % to 20 mass %, and preferably about 1 mass % to 10 mass % based on the total amount of the cyan ink composition.

Examples of pigments for use in a magenta ink composition include C.I. pigment red 5, 7, 12, 48 (Ca), 48 (Mn), 57 (Ca), 57:1, 112, 122, 123, 168, 184, and 202 and C.I. pigment violet 19 and preferably, examples include a single pigment or a mixture of two or more pigments selected from the group consisting of C.I. pigment red 122, 202, and 209 and C.I. pigment violet 19. The content of the pigments is about 0.5 mass % to 20 mass % and preferably about 1 mass % to 10 mass % based on the total amount of the magenta ink composition.

Examples of pigments for use in a yellow ink composition include C.I. pigment yellow 1, 2, 3, 12, 13, 14C, 16, 17, 73, 74, 75, 83, 93, 95, 97, 98, 119, 110, 114, 128, 129, 138, 150, 151, 154, 155, 180, and 185 and preferably, examples include a single pigment or a mixture of two or more pigments selected from the group consisting of C.I. pigment yellow 74, 109, 110, 128, 138, 180, and 185. The content of the pigments is about 0.5 mass % to 20 mass % and preferably about 1 mass % to 10 mass % based on the total amount of the yellow ink composition.

As a pigment for use in an orange ink composition, C.I. pigment orange 36 or 43 or a mixture thereof is mentioned. The content of the pigments is about 0.5 mass % to 20 mass % and preferably about 1 mass % to 10 mass % based on the total amount of the orange ink composition.

As a pigment for use in a green ink composition, C.I. pigment green 7 or 36 or a mixture thereof is mentioned. The content of the pigments is about 0.5 mass % to 20 mass % and preferably about 1 mass % to 10 mass % based on the total amount of the green ink composition.

In order for the above-mentioned pigments to be more stably dispersed and held in the ink composition, various kinds of methods can be applied. Examples of the methods include a dispersing method using a resin dispersing agent, a dispersing method using a surfactant, and a method for rendering the pigment dispersible and/or soluble by chemically and/or physically introducing a hydrophilic functional group into the surface of pigment particles. Any of the methods above can be used for the water-based ink for use in the recording method according to this Embodiment, and, as required, the methods can be used in combination. The ink composition of this Embodiment contains a water-soluble resin described later and the water-soluble resin also functions as the resin dispersing agent, and thus the description of the method using the resin dispersing agent is omitted.

Examples of surfactants that can be used for dispersing pigments include anionic surfactants, such as alkane sulfonate salts, α-olefin sulfonate salts, alkylbenzene sulfonate salts, alkylnaphthalene sulfonate salts, acylmethyl taurate salts, dialkyl sulfosuccinate salts, alkyl sulfate ester salts, olefin sulfates, polyoxyethylene alkyl ether sulfate ester salts, alkyl phosphate ester salts, polyoxyethylene alkyl ether phosphate ester salts, or monoglycerite phosphate ester salts, amphoteric surfactants, such as alkyl pyridium salts, alkylamino acid salts, or alkyldimethyl betaines, and nonionic surfactants, such as polyoxyethylene alkyl ethers, polyoxyethylene alkylphenyl ethers, polyoxyethylene alkyl esters, polyoxyethylene alkylamides, glycerol alkyl esters, or sorbitan alkyl esters.

The addition amount of the resin dispersing agent or the surfactant mentioned above relative to the pigment is preferably 1 mass % to 100 mass % and more preferably 5 mass % to 50 mass % per mass % of the pigment. Based on the fact that the addition amount thereof is in the range, dispersion stability of the pigment in water can be secured.

Examples of the method for rendering the pigment dispersible and/or soluble by chemically and/or physically introducing a hydrophilic functional group into the surface of pigment particles include a method for introducing as a hydrophilic functional group, into the pigment, —OM, —COOM, —CO—, —SO3M, —SO2NH2, —RSO2M, —PO3HM, —PO3M2, —SO2NHCOR, —NH3, —NR3 (in Formulae, M represents a hydrogen atom, an alkali metal, ammonium, or organic ammonium, R represents an alkyl group having 1 to 12 carbon atoms, a phenyl group that may have a substituent, or a naphthyl group that may have a substituent.). These functional groups are physically and/or chemically introduced into the surface of pigment particles by grafting thereon directly or through another group. Examples of polyvalent groups include alkylene groups having 1 to 12 carbon atoms, a phenyl group that may have a substituent, and a naphthyl group that may have a substituent.

As the surface treatment method, a method for surface treating the surface of pigment particles with a treatment agent containing sulfur so that —SO3M and/or —RSO2M (M is a counter ion and represents a hydrogen ion, an alkali metal ion, an ammonium ion, or an organic ammonium ion) are/is chemically bonded to the surface of the pigment particles, i.e., a method for rendering the pigment dispersible and/or soluble in water by dispersing the pigment in a solvent which has no active protons and has no reactivity with sulfonic acid and in which the pigment is insoluble or difficult to dissolve, and then surface treating the same so that SO3M and/or —RSO2M are/is chemically bonded to the surface of the particles by amidosulfuric acid or a complex of sulfur trioxide and tertiary amine, is more preferable.

As a surface treating measure for grafting the functional group or a salt thereof on the surface of the pigment particles directly or through a polyvalent group, various known surface treating measures are applicable. Examples include a measure including acting ozone or a sodium hypochlorite solution on a commercially available carbon black oxide, and further oxidizing the carbon black for further hydrophilizing the surface (e.g., JP-A Nos. 7-258578, 8-3498, 10-120958, 10-195331, and 10-237349), a measure for treating carbon black with a 3-amino-N-alkyl-substituted pyridium bromide (e.g., JP-A Nos. 10-195360 and 10-330665), a measure including dispersing an organic pigment in a solvent in which the organic pigment is insoluble or difficult to dissolve, and introducing a sulfone group into the surface of pigment particles by a sulfonating agent (e.g., JP-A Nos. 8-283596, 10-110110, and 10-110111), and a measure for dispersing an organic pigment in a basic solvent forming a complex with sulfur trioxide, and surface treating the surface of the organic pigment by adding sulfur trioxide for introducing a sulfone group or a sulfone amino group (e.g., JP-A No. 10-110114). The measures for producing the surface treated pigments for use in the invention are not limited to these measures.

A single type or a plurality of types of functional groups may be grafted on one carbon black particle. The type and the grafting degree of the functional group(s) to be grafted may be determined as appropriate considering dispersion stability in ink, color density, and drying properties on the front surface of an ink jet head.

The method for dispersing a pigment in water can be carried out by adding, for a resin dispersing agent, a pigment, water, and resin, adding, for a surfactant, a pigment, water, and a surfactant, and, for a surface treated pigment, adding the pigment and water, and, as required, adding a water soluble organic solvent, a neutralizer, etc., to each thereof in a disperser used in former cases, such as a ball mill, a sand mill, an attritor, a roll mill, an agitator mill, a Henschel mixer, a colloid mill, an ultrasonic homogenizer, a jet mill or an Ong Mill. In this case, it is preferable to disperse the pigment until the particle diameter of the pigment becomes 20 nm to 500 nm and more preferably 50 nm to 200 nm in terms of average particle diameter from the viewpoint of securing dispersion stability of the pigment in water.

### Water-Soluble Resin

The water-based ink for use in the recording method according to this Embodiment contains a water-soluble resin. One of the functions of the water-soluble resin is to improve the dispersibility of the pigments mentioned above. Another one of the functions of the water soluble resin composition is to improve the adhesiveness between the recording medium and the ink composition, and/or the solids in the ink composition when the ink composition adheres to the recording medium. Examples of the water-soluble resin include polyvinyl alcohols, polyvinyl pyrrolidones, polyacrylic acids, acrylic acid-acrylicnitrile copolymers, vinyl acetate-acrylic acid ester copolymers, acrylic acid-acrylic acid ester copolymers, styrene-acrylic acid copolymers, styrene-methacrylic acid copolymers, styrene-methacrylic acid-acrylic acid ester copolymers, styrene-α-methylstyrene-acrylic acid copolymers, styrene-α-methylstyrene-acrylic acid-acrylic acid ester copolymers, styrene-maleic acid copolymers, styrene-maleic anhydride copolymers, vinyl naphthalene-acrylic acid copolymers, vinyl naphthalene-maleic acid copolymers, vinyl acetate-maleic acid ester copolymers, vinyl acetate-crotonic acid copolymers, and vinyl acetate-acrylic acid copolymers, and salts thereof. Among the above, copolymers of monomers having hydrophobic functional groups and monomers having hydrophilic functional groups and polymers composed of monomers having both hydrophobic functional groups and hydrophilic functional groups are preferable. As the form of copolymers, any form of a random copolymer, a block copolymer, an alternating copolymer, and a graft copolymer can be used.

Examples of the salts include salts with basic compounds, such as ammonia, ethylamine, diethylamine, triethylamine, propylamine, isopropylamine, dipropylamine, butylamine, isobutylamine, diethanolamine, triethanolamine, tri-iso-propanolamine, aminomethyl propanol, or morpholine. The addition amount of these basic compounds is not limited insofar as the addition amount thereof is equal to or more than the neutralization equivalent of the water-soluble resin.

The molecular weight of the water-soluble resin is preferably in the range of 1,000 to 100000 and more preferably 3,000 to 10000 in terms of weight average molecular weight. Based on the fact that the molecular weight is in the range above, stable dispersion of a colorant in water is achieved and it is easy to carry out viscosity control or the like when applied to an ink composition. The acid value is preferably in the range of 50 to 300 and more preferably in the range of 70 to 150. Based on the fact that the acid value is in the range above, dispersibility of color particles in water can be stably secured and the water resistance of printed matter obtained by printing with an ink composition using the same is favorable.

Commercially available water-soluble resins can also be used as the water-soluble resin described above. In detail, JONCRYL 67 (weight average molecular weight: 12,500, acid value: 213), JONCRYL 678 (weight average molecular weight: 8,500, acid value: 215), JONCRYL 586 (weight average molecular weight: 4, 600, acid value: 108), JONCRYL 611 (weight average molecular weight: 8,100, acid value: 53), JONCRYL 680 (weight average molecular weight: 4,900, acid value: 215), JONCRYL 682 (weight average molecular weight: 1,700, acid value: 238), JONCRYL 683 (weight average molecular weight: 8,000, acid value: 160), JONCRYL 690 (weight average molecular weight: 16,500, acid value: 240) (trade names, manufactured by BASF Japan, Inc.), etc., are mentioned.

### Thermoplastic Resin Particles

The water-based ink for use in the recording method according to this Embodiment contains thermoplastic resin particles. The thermoplastic resin particles have an action of firmly fixing ink solidified matter on a recording medium after ink dries. Printed matter obtained by printing with an ink composition containing resin particles by the action is excellent in scratch resistance on a non-ink absorbing or a low-ink absorbing recording medium. To the water-based ink for use in the recording method according to this Embodiment, thermoplastic resin particles that are thoroughly dissolved in the ink composition may be added, and thermoplastic resin particles that are dispersed as particles in the ink composition (i.e., an emulsion state or a suspension state) may be blended.

Examples of components constituting the thermoplastic resin particles include polyacrylic acids or copolymers thereof, polymethacrylic acid esters or copolymers thereof, polyacrylonitriles or copolymers thereof, polycyanoacrylates, polyacrylamides, polyacrylic acids, polymethacrylic acids, polyethylenes, polypropylenes, polybutenes, polyisobutylenes, polystyrenes or copolymers thereof, petroleum resins, chroman•indene resins, terpene resins, polyvinyl acetates or copolymers thereof, polyvinyl alcohols, polyvinyl acetals, polyvinyl ethers, polyvinyl chlorides or copolymers thereof, polyvinylidene chlorides, fluororesins, fluororubbers, polyvinyl carbazoles, polyvinyl pyrrolidones or copolymers thereof, polyvinyl pyridines, polyvinyl imidazoles, polybutadienes or copolymers thereof, polychloroprenes, polyisoprenes, and natural resins. Among the above, particularly components having both a hydrophobic portion and a hydrophilic portion in the molecular structure are more preferable.

As the thermoplastic resin particles described above, those obtained by known materials and methods can also be used. For example, those described in JP-B No. 62-1426, JP-A Nos. 3-56573, 3-79678, 3-160068, and 4-18462, etc., may also be used. Moreover, commercially available thermoplastic resin particles can also be used. Examples include Microgel E-1002 and Microgel E-5002 (trade names, manufactured by Nippon Paint Co., Ltd.), Boncoat 4001 and Boncoat 5454 (trade names, manufactured by Dainippon Ink & Chemicals, Inc.), SAE1014 (trade name, manufactured by Nippon Zeon Co., Ltd.), Saibinol SK-200 (trade name, manufactured by SAIDEN CHEMICAL INDUSTRY CO., LTD.), JONCRYL 7100, JONCRYL 390, JONCRYL 711, JONCRYL 511, JONCRYL 7001, JONCRYL 632, JONCRYL 741, JONCRYL 450, JONCRYL 840, JONCRYL 74J, JONCRYL HRC-1645J, JONCRYL 734, JONCRYL 852, JONCRYL 7600, JONCRYL 775, JONCRYL 537J, JONCRYL 1535, JONCRYL PDX-7630A, JONCRYL 352J, JONCRYL 352D, JONCRYL PDX-7145, JONCRYL 538J, JONCRYL 7640, JONCRYL 7641, JONCRYL 631, JONCRYL 790, JONCRYL 780, and JONCRYL 7610 (trade names, manufactured by BASF Japan, Inc.).

The thermoplastic resin particles are obtained by methods described below, and any method of the methods is acceptable. As required, thermoplastic resin particles may be obtained by combining a plurality of methods. Examples of the methods include a method including mixing a polymerization catalyst (polymerization initiator) and a dispersing agent in monomers of components constituting desired thermoplastic resin particles, and polymerizing the same (i.e., emulsion polymerization), a method including dissolving a thermoplastic resin having a hydrophilic portion in a water soluble organic solvent, mixing the solution in water, and removing the water soluble organic solvent by distillation or the like, thereby obtaining thermoplastic resin particles, and a method including dissolving a thermoplastic resin in a water-insoluble organic solvent, and mixing the solution in an aqueous solution with a dispersing agent, thereby obtaining thermoplastic resin particles. The methods can be suitably selected according to the type and the properties of the thermoplastic resin to be used. There is no limitation on a dispersing agent that can be used for dispersing thermoplastic resin particles. Examples include anionic surfactants (e.g., a sodium dodecylbenzenesulfonate salt, a laurylphosphate sodium salt, and a polyoxyethylene alkyl ether sulfate ammonium salt), and nonionic surfactants (e.g., polyoxyethylene alkyl ether, polyoxyethylene alkyl ester, polyoxyethylene sorbitan fatty acid ester, and polyoxyethylene alkyl phenyl ether). The surfactants can be used singly or as a mixture of two or more thereof.

The average particle diameter of the thermoplastic resin particles is in the range of 5 nm to 400 nm and more preferably 50 nm to 200 nm from the viewpoint of securing the storage stability and the discharging stability of water-based ink.

The content of the thermoplastic resin particles is preferably 0.1 mass % to 15 mass % and more preferably 0.5 mass % to 10 mass % in terms of solid content based on the total amount of the water-based ink. Based on the fact that the content thereof is in the range above, the water-based ink for use in the recording method according to this Embodiment can be solidified and fixed also on a non-ink absorbing or low-ink absorbing recording medium. When the content thereof is lower than 0.1 mass %, the strength of ink solidification and fixation becomes weak, and thus the ink becomes easy to separate from the surface of the recording medium in some cases. In contrast, when the content thereof exceeds 15 mass, the storage stability and the discharging stability of the water-based ink cannot be secured in some cases.

### Silicon Surfactant

The water-based ink for use in the recording method according to this Embodiment contains a silicon surfactant. The silicon surfactant has an action of uniformly spreading the ink so as not to cause inconsistent ink density or ink blur on a recording medium. The content of the silicon surfactant is preferably 0.1 mass % to 1.5 mass % based on the total amount of the ink composition. When the content of the silicon surfactant is lower than 0.1 mass %, the ink is difficult to uniformly wet spread on a recording medium, and thus inconsistent ink density or ink blur is likely to occur. In contrast, the content of the silicon surfactant exceeds 15 mass %, it becomes difficult to dissolve in the ink or does not dissolve in the ink, in some cases, and thus the storage stability of the ink deteriorates by the development of insoluble matter.

As a silicon surfactant, polysiloxane compounds and the like are preferably used, and, for example, polyether-modified organosiloxane and the like are mentioned. In more detail, examples inclde BYK-306, BYK-307, BYK-333, BYK-341, BYK-345, BYK-346, and BYK-348 (trade names, manufactured by BYK chemmie Japan, Inc.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, manufactured by Shin-Etsu Chemicals Co., Ltd.).

### Water

The water-based ink for use in the recording method according to this Embodiment contains water. Water is a medium that serves as a main component of the ink composition, and is a component that volatilizes in a drying process described later.

The water is preferably water from which ionic impurities are removed as much as possible, such as pure water, such as ion exchanged water, ultrafiltration water, reverse osmosis water, or distilled water, or ultrapure water. When water that has been sterilized by UV irradiation or addition of hydrogen peroxide is used, the development of mold or bacteria can be prevented when a pigment dispersion liquid and an ink composition using the same are stored over a long period of time, and thus such water is preferable.

### Other Additives

The water-based ink for use in the recording method according to this Embodiment contains the first solvent, the second solvent, the colorant, the water-soluble resin, the thermoplastic resin particles, the silicon surfactant, and the water described above. With the composition, the ink can form printed matter having less inconsistent ink density and ink blur even on a non-ink absorbing or low-ink absorbing recording material and excellent scratch resistance and makes it difficult to cause clogging of a nozzle. From the viewpoint of further increasing the properties, an acetyleneglycol surfactant, an antiseptic agent•antifungal agent, a pH adjuster, a chelating agent, etc., can be added.

Examples of acetyleneglycol surfactants include Surfinol 104, 104E, 104H, 104A, 104BC, 104DPM, 104PA, 104PG-50, 1045, 420, 440, 465, 485, SE, SE-F, 504, 61, DF37, CT111, CT121, CT131, CT136, TG, and GA (trade names, all manufactured by Air Products and Chemicals. Inc.), Olfine B, Y, P, A, STG, SPC, E1004, E1010, PD-001, PD-002W, PD-003, PD-004, EXP. 4001, EXP. 4036, EXE. 4051, AF-103, AF-104, AK-02, SK-14, and AE-3 (trade names, all manufactured by Nisshin Chemical Industry Co., Ltd.), ACETYLENOL E00, E00P, E40, and E100 (trade names, manufactured by Kawaken Fine Chemicals Co., Ltd.).

Examples of pH adjustors include potassium dihydrogenphosphate, disodium hydrogenphosphate, sodium hydroxide, lithium hydroxide, potassium hydroxide, ammonia, diethanolamine, triethanolamine, tri-isopropanolamine, potassium carbonate, sodium carbonate, and sodium hydrogencarbonate.

Examples of antiseptic agents and antifungal agents include sodium benzoate, sodium pentachlorophenol, sodium 2-pyridinethiol-1-oxide, sodium sorbinate, sodium dehydroacetate, and 1,2-benziso thiazoline-3-one. Examples of commercially available antiseptic agents and antifungal agents include proxel XL2 and Proxel GXL (trade names, all manufactured by Avecia), and Denicide CSA and NS-500W (trade names, manufactured by Nagase ChemteX Corp.).

As antirust agents, benzotriazole and the like are mentioned, for example.

Examples of chelating agents include ethylenediaminetetraacetic acid and salts thereof (e.g., ethylenediaminetetraacetic acid disodium salt dihydrate).

### Physical Properties of Water-Based Ink

The pH of the water-based ink is preferably neutral or alkaline and more preferably is in the range of 7.0 to 10.0. When the pH is acidic, the storage stability and dispersion stability of an ink composition is impaired in some cases. Moreover, defects, such as corrosion of metal components for use in an ink flow path in an ink jet recording device, are likely to occur. The pH can be adjusted to neutrality or alkalinity using the pH adjustor mentioned above.

The viscosity of the water-based ink is preferably in the range of 1.5 mPa·s to 15 mPa·s at 20° C. When the viscosity of the water-based ink is in the range, the discharging stability of ink can be secured in a first process described later.

The surface tension of the water-based ink is preferably 20 mN/m to 40 mN/m and more preferably 25 mN/m to 35 mN/m at 25° C. When the surface tension of the water-based ink is in the range above, the discharging stability of ink can be secured and proper wettability to a non-ink absorbing or low-ink absorbing recording medium can be secured in a first process described later.

The heating temperature of the medium during recording is preferably 40° C. to 80° C.

By adjusting the heating temperature to 40° C. to 80° C., the development of inconsistent drying and deterioration of a recording medium can be prevented while preventing ink blur due to ink flowing.

The heating temperature of the medium during recording is more preferably 40° C. to 50° C.

By adjusting the heating temperature to 40° C. to 50° C., the development of inconsistent drying can be further prevented.

The ink cartridge of the invention contains a water-based ink having a first solvent having a boiling point of 210° C. to 280° C., a second solvent having a boiling point of 150° C. to 280° C., a water-insoluble colorant, a water-soluble resin, thermoplastic resin particles, a silicon surfactant, and water, in which the surface tension when the first solvent is formed into an aqueous solution is lower than the surface tension when the second solvent is formed into an aqueous solution.

### Method for Producing Water-Based Ink

The water-based ink for use in the recording method according to this Embodiment is obtained by mixing the materials mentioned above in an arbitrary order, and, as required, filtering for removing impurities. Here, it is preferable in terms of ease of handling or the like to mix a colorant after uniformly dispersing with a water-soluble resin in advance.

As a method for mixing the respective materials, a method including successively placing the materials in a container having a stirrer, such as a mechanical stirrer or a magnetic stirrer, and stirring and mixing the same is preferably used. As a filtering method, centrifugal filtration, filtering, etc., can be carried out as required.

The recording device of the invention is used in the ink jet recording method described above.

The recording device of the invention has the ink cartridge described above.

### EXAMPLES

Hereinafter, the invention will be described in detail according to Examples and Comparative Examples, but is not limited thereto.

### Preparation of Pigment Dispersion Liquid

In water-based ink to be used in this Example, a water-insoluble pigment is used as a colorant. When the pigment was added to an ink composition, the pigment was dispersed with a water-soluble resin in advance.

The pigment dispersion liquid was prepared as follows. First, to 84.4 parts by mass of ion exchanged water in which 0.6 part by mass of 30 aqueous ammonia solution (neutralizer) was dissolved, 3 parts by mass of acrylic acid-acrylic acid ester copolymer (weight average molecular weight: 25,000, acid value: 180) was added as a water-soluble resin for dissolution. To the solution, 12 parts by mass of the following pigments were added, and dispersed using zirconia beads for 10 hours in a ball mill. Thereafter, centrifugal filtration by a centrifugal separator was carried out to remove impurities, such as coarse particles or wastes, and the pigment concentration was adjusted to be 12 mass %. The types of the pigments used in the production of the pigment dispersion liquid are shown below.

Carbon black MA77 (trade name, manufactured by Mitsubishi Chemical Corp., used in a black pigment dispersion liquid)

C.I. pigment yellow 74 (used in a yellow pigment dispersion liquid)

C.I. pigment red 122 (used in a magenta pigment dispersion liquid)

C.I. pigment blue 15:3 (used in a cyan pigment dispersion liquid)

### Preparation of Ink Composition and Ink Set

Ink compositions were prepared using organic solvents shown in Table 1 and the composition shown in Table 2. First, ink compositions of four colors of black, yellow, magenta, and cyan were prepared using the pigment dispersion liquid prepared in the “Preparation of pigment dispersion liquid” above based on the material composition shown in Tables 1 and 2 to provide one ink set. Then, ink sets having different compositions of Examples 1 to 4 and Comparative Examples 1 to 4 were obtained. Each ink composition was prepared by placing the materials shown in Tables 1 and 2 in a container, stirring and mixing the same with a magnetic stirrer for 2 hours, and filtering the same through a membrane filter having a pore size of 5 μm to remove impurities, such as wastes or coarse particles. The numerical values in Tables 1 and 2 all represent mass %, and ion exchanged water was added so that the composition was finally as shown in Table 2.

In Table 1, the numerical values of the surface tension are numerical values when formed into a 50 mass % aqueous solution.

In Table 2, a styrene-acrylic acid copolymer was used as thermoplastic resin particles. “BYK-348” used as a silicon surfactant is a trade name, and is a product manufactured by BYK chemmie Japan, Inc.

TABLE 1

| | | | | | | | | Comparative | | | |
|---|---|---|---|---|---|---|---|---|---|---|---|
| | Boiling | Surface | | Examples | | | | examples | | | |
| | point | tension | | 1 | 2 | 3 | 4 | 1 | 2 | 3 | 4 |
| First | 170° C. | 30.5 | Ethylene glycol | 0 | 0 | 0 | 0 | 6 | 3 | 6 | 3 |
| solvent | | | monobutyl ether | | | | | | | | |
| First | 223° C. | 26.7 | 1,2-hexanediol | 6 | 3 | 6 | 3 | 0 | 0 | 0 | 0 |
| solvent | | | | | | | | | | | |
| Second | 187° C. | 44.7 | Propyleneglycol | 5 | 10 | 0 | 0 | 5 | 10 | 0 | 0 |
| solvent | | | | | | | | | | | |
| Second | 245° C. | 49.8 | Diethylene | 0 | 0 | 5 | 10 | 0 | 0 | 5 | 10 |
| solvent | | | glycol | | | | | | | | |

TABLE 2

| | | |
|---|---|---|
| Colorant | As follows | 4 |
| Dispersing agent of | Acrylic acid-acrylic | 1 |
| colorant (water- | acid ester copolymer | |
| soluble resin) | | |
| Thermoplastic resin | Stylene-acrylic acid | (Solid content) 2.5 |
| particles | copolymer | |
| Surfactant | BYK-348 | 0.5 |
| | (manufactured by BYK | |
| | chemmie Japan, Inc.) | |
| | (silicon surfactant) | |
| Pure water | | Balance to give a |
| | | total amount of 100 |

### Printing Test

PX-G930 (manufactured by Seiko Epson Corporation) was partially converted to produce a printer capable of heat adjusting a printing medium during printing. Then, the medium were heated to 50° C. using the printer, and a printing test was carried out using the ink compositions of Examples and Comparative Examples.

As the printing medium, a non-absorbing recording medium having a target recording surface of a plastic film and a cold laminate film PG-50L (material: PET, manufactured by LAMI CORPORATION, INC.) were used.

### Image Quality

A solid pattern was used as a printing pattern, and printing was carried out in a heating process (heating temperatures of 50° C. and 30° C.) during printing. Immediately after printing, printed matter was dried for 1 minute with a 60° C. dryer. Then, the resultant was confirmed whether or not inconsistent ink density or inconsistent ink drying occurred.

### o: Inconsistency

Δ: Slight inconsistency
x: Remarkable inconsistency

### Drying State

Printing was carried out using the printing pattern above (heating temperature of 50° C.), and, immediately after printing, printed matter was dried for 1 minute with a 60° C. dryer. Thereafter, stickiness in a printed portion was analyzed after 1 hour passed and 24 hours passed at room temperature.

o: No stickiness in a printed portion
x: Stickiness in a printed portion

Evaluation results are shown in Table 3.

TABLE 3

| | | | | | | Comparative | | | |
|---|---|---|---|---|---|---|---|---|---|
| | | Examples | | | | examples | | | |
| | | 1 | 2 | 3 | 4 | 1 | 2 | 3 | 4 |
| Image quality at a | Dot size 30 ng | ∘ | ∘ | Δ | Δ | x | x | x | x |
| heating temperature of | Dot size 15 ng | ∘ | ∘ | ∘ | ∘ | Δ | x | x | x |
| 20° C. during printing | | | | | | | | | |
| Image quality at a | Dot size 30 ng | ∘ | Δ | Δ | Δ | x | x | x | x |
| heating temperature of | | | | | | | | | |
| 40° C. during printing | | | | | | | | | |
| Same as above | Dot size 15 ng | ∘ | ∘ | ∘ | ∘ | x | x | x | x |
| Image quality at a | Dot size 30 ng | x | x | | | | | | |
| heating temperature of | Dot size 15 ng | x | x | | | | | | |
| 30° C. during printing | | | | | | | | | |
| (Comparative Example) | | | | | | | | | |
| Drying state | 1 hour after | ∘ | ∘ | x | x | ∘ | ∘ | ∘ | x |
| (stickiness) | printing | | | | | | | | |
| (Dot size 30 ng) | 24 hours after | ∘ | ∘ | ∘ | ∘ | ∘ | ∘ | ∘ | ∘ |
| | printing | | | | | | | | |

As shown in Table 3, nonuniform agglomeration did not occur and image quality was excellent in Examples 1 to 4. In particular, the dot size can be enlarged in Examples 1 and 2, the printing speed can be increased. In contrast, nonuniform agglomeration occurred in the Comparative Examples.

What is claimed is:

1. An ink jet recording method for forming an image by adhering water-based ink to a non-absorbing or low-absorbing medium,
the method comprising:
forming an image while heating the medium,
the water-based ink containing a first solvent having a boiling point of 210° C. to 280° C., a second solvent having a boiling point of 150° C. to 280° C., a water-insoluble colorant, a water-soluble resin, thermoplastic resin particles, a silicon surfactant, and water, and
the surface tension when the first solvent being formed into an aqueous solution being lower than the surface tension when the second solvent being formed into an aqueous solution.

2. The ink jet recording method according to claim 1, wherein the boiling point of the second solvent is 150° C. to lower than 210° C. and the amount of ink droplets to be adhered to the medium is 3 ng to 30 ng.

3. The ink jet recording method according to claim 1, wherein the boiling point of the second solvent is 210° C. to 280° C. and the amount of ink droplets to be adhered to the medium is 3 ng to 15 ng.

4. The ink jet recording method according to claim 1, wherein the content of the silicon surfactant in the water-based ink is 0.1 mass % to 1.5 mass %.

5. The ink jet recording method according to claim 1, wherein the heating temperature of the medium is 40° C. to 80° C.

6. An ink cartridge, comprising water-based ink containing a first solvent having a boiling point of 210° C. to 280° C., a second solvent having a boiling point of 150° C. to 280° C., a water-insoluble colorant, a water-soluble resin, thermoplastic resin particles, a silicon surfactant, and water,
the surface tension when the first solvent being formed into an aqueous solution being lower than the surface tension when the second solvent being formed into an aqueous solution.

7. A recording device, which is used for the ink jet recording method according to claim 1.

8. A recording device, having the ink cartridge according to claim 6.
